(19) United States
(12) Patent Application Publication
(10) Pub. No.: US 2026/0253615 A1
(43) Pub. Date: Aug. 27, 2026

(54) INFORMATION PROCESSING SYSTEM AND INFORMATION PROCESSING METHOD

(71) Applicant: HONDA MOTOR CO., LTD., Tokyo (JP)

(72) Inventor: Ayaka Nobuchi, Tokyo (JP)

(21) Appl. No.: 19/457,990

(22) Filed: Jan. 23, 2026

(30) Foreign Application Priority Data
Feb. 21, 2025 (JP) 2025-026938

(51) Int. Cl. G11B 27/036; G06V 20/56; G06V 20/59; G06V 20/70; G11B 27/34

(52) U.S. Cl. CPC G11B 27/036; G06V 20/56; G06V 20/59; G06V 20/70; G11B 27/34

(57) ABSTRACT

An information processing system includes: an event detection unit configured to detect occurrence of an event inside and outside a vehicle; an information acquisition unit configured to acquire event related information related to the event; a tag creation unit configured to create an editing tag based on the event related information; and a creation unit configured to create content based on the editing tag.

### INCORPORATION BY REFERENCE

The present application claims priority under 35 U.S.C. § 119 to Japanese Patent Application No. 2025-026938 filed on Feb. 21, 2025. The content of the application is incorporated herein by reference in its entirety.

### BACKGROUND OF THE INVENTION

### Field of the Invention

The present invention relates to an information processing system and an information processing method.

### Description of the Related Art

A technology is known in which a communication cost according to a transmission information amount is suppressed by analyzing a moving image, converting it to text information, and transmitting the converted text information to another device. For example, Japanese Patent Laid-Open No. 10-40482 discloses a system that converts video information and voice information obtained from a video camera and a microphone to text information and transmits the text information to another device.

Now, in a content creation technology utilizing generative AI (Artificial Intelligence), it has been studied to provide a content creation service that creates content based on moving images photographed by an in-vehicle camera. However, since a large amount of data is needed to edit content, if data of moving images photographed by an in-vehicle camera is transmitted to a server on a cloud and edited in the server on the cloud, in addition to excessive increase of a communication cost, it takes time to generate content and marketability may decline.

In order to solve the problem described above, an object of the present application is to suppress decline of marketability by suppressing a communication cost and shortening editing time of moving images in a content creation service.

### SUMMARY OF THE INVENTION

One aspect to achieve the object is an information processing system including an event detection unit configured to detect occurrence of an event inside and outside a vehicle, an information acquisition unit configured to acquire event related information related to the event, a tag creation unit configured to create an editing tag based on the event related information, and a creation unit configured to create content based on the editing tag.

According to one aspect of the present invention, in a content creation service, since a communication cost is suppressed and content editing time is shortened, marketability can be improved.

### BRIEF DESCRIPTION OF THE DRAWINGS

FIG. 1 is a diagram illustrating a configuration of an information processing system according to one embodiment of the present invention;

FIG. 2 is a diagram illustrating a configuration of a vehicle in Embodiment 1;

FIG. 3 is a diagram illustrating a configuration of an information processing server in Embodiment 1;

FIG. 4 is a diagram illustrating a configuration of a terminal device in Embodiment 1;

FIG. 5 is a flowchart illustrating first processing performed by an in-vehicle device in Embodiment 1;

FIG. 6 is a flowchart illustrating second processing performed by the information processing server in Embodiment 1;

FIG. 7 is a flowchart illustrating third processing performed by the terminal device in Embodiment 1;

FIG. 8. is an explanatory diagram illustrating a specific example of an editing tag in Embodiment 1;

FIG. 9 is a diagram illustrating a configuration of the vehicle in Embodiment 2;

FIG. 10 is a diagram illustrating a configuration of the information processing server in Embodiment 2;

FIG. 11 is a flowchart illustrating first processing performed by the in-vehicle device in Embodiment 2;

FIG. 12 is a flowchart illustrating second processing performed by the information processing server in Embodiment 2; and

FIG. 13 is an explanatory diagram illustrating a specific example of the editing tag in Embodiment 2.

### DETAILED DESCRIPTION OF THE INVENTION

Hereinafter, embodiments of the present invention will be described with reference to the drawings.

### Embodiment 1

### 1. Configuration of Information Processing System

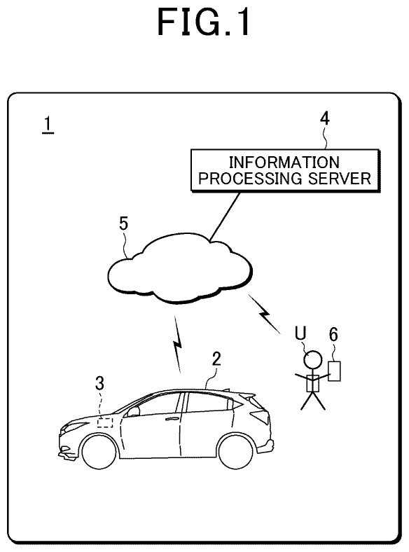

FIG. 1 is a diagram illustrating the configuration of an information processing system 1 according to one embodiment of the present invention. The information processing system 1 includes an in-vehicle device 3 loaded in a vehicle 2, an information processing server 4 which is a server device provided outside the vehicle 2, and a terminal device 6 possessed by a user U utilizing the vehicle 2. The in-vehicle device 3, the information processing server 4, and the terminal device 6 are connected so as to communicate with each other via a communication network 5 such as the Internet, for example.

The vehicle 2 is, for example, a vehicle that is electrically driven or is driven by an internal combustion engine. The terminal device 6 may be a portable or carriable terminal device such as a smartphone, a tablet PC, and a notebook PC, or a stationary terminal device such as a desktop PC. In the present embodiment, the terminal device 6 is a smartphone possessed by the user U, for example.

The user U selects an optional function of the vehicle 2 and transmits a request to start the utilization to the information processing server 4 by operating the terminal device 6. Upon receiving the request to start the utilization, the information processing server 4 instructs the in-vehicle device 3 of the vehicle 2 to prepare to execute the optional function specified by the request.

The information processing system 1 is configured to detect occurrence of an event and to create content based on details of the detected event. Specifically, the in-vehicle device 3 is configured, when the occurrence of an event is detected, to create an editing tag regarding the detected event and to transmit it to the information processing server 4. The information processing server 4 is configured to create the content based on the received editing tag and to transmit it to the terminal device 6. The terminal device 6 is configured to reproduce the received content. An event is a phenomenon such as the vehicle 2 traveling through a location with great scenery, a scenic spot, or a popular spot, or an inside of the vehicle 2 getting lively. The occurrence of an event is detected when information such as image information acquired from a camera, voice information acquired from a microphone, and position information satisfies a specific condition, as to be described later.

Hereinafter, configurations of the vehicle 2 provided with the in-vehicle device 3, the information processing server 4, and the terminal device 6 will be successively described.

### 2. Configuration of Vehicle

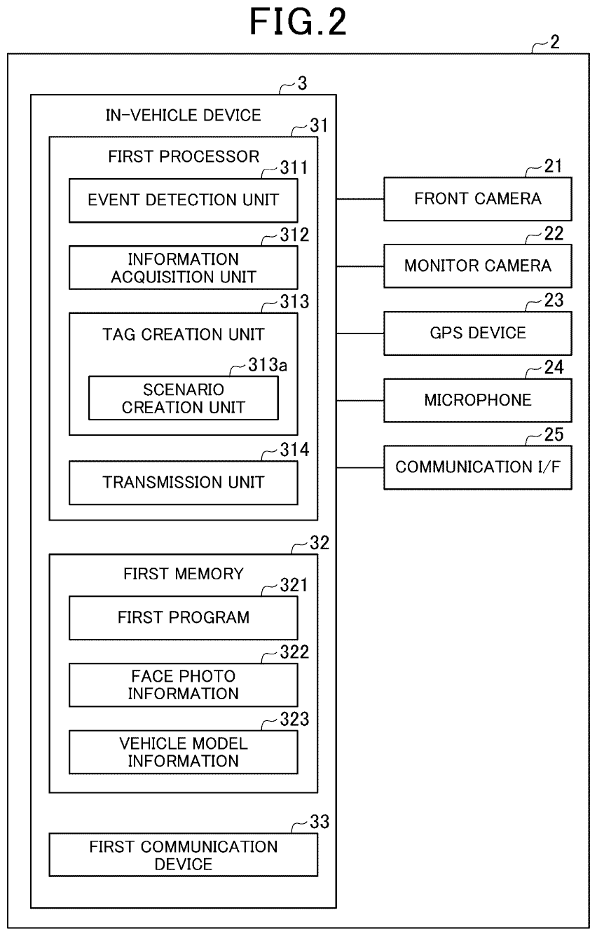

First, the vehicle 2 and the in-vehicle device 3 provided in the vehicle 2 will be described. FIG. 2 is a diagram illustrating the configuration of the vehicle 2 in Embodiment 1. The vehicle 2 includes the in-vehicle device 3, a front camera 21 configured to photograph an outside front of the vehicle 2, a monitor camera 22 configured to photograph the inside of the vehicle 2, a GPS device 23 configured to acquire position information of the vehicle 2 and date and time information, a microphone 24 configured to collect voice inside the vehicle 2, and a communication I/F 25 (transmitter/receiver, circuit).

The in-vehicle device 3 includes a first processor 31, a first memory 32, and a first communication device 33. The first memory 32 is formed of, for example, a nonvolatile semiconductor memory, or volatile and nonvolatile semiconductor memories. The first memory 32 may include an auxiliary storage device such as a hard disk device.

The first processor 31 is, for example, a computer provided with a CPU or the like. The first processor 31 may include a ROM in which a program is written and a RAM for temporary storage of data or the like. Then, as functional elements or functional units, the first processor 31 is provided with an event detection unit 311, an information acquisition unit 312, a tag creation unit 313 including a scenario creation unit 313a, and a transmission unit 314.

These functional elements provided in the first processor 31 are realized by, for example, the first processor 31, which is a computer, executing a first program 321 preserved in the first memory 32. Note that the first program 321 can be stored in an arbitrary computer-readable storage medium. Alternatively, all or a part of the functional elements provided in the first processor 31 may be formed of hardware each including one or more electronic circuit components.

The event detection unit 311 detects the occurrence of an event inside and outside the vehicle 2. The event detection unit 311 detects the occurrence of an event based on at least one of photographed moving image information acquired from the front camera 21 and the monitor camera 22, position information acquired from the GPS device 23, and voice information acquired from the microphone 24.

In the present embodiment, the event detection unit 311 determines that an event is detected when the photographed moving image information includes an image of the sea at dusk, a mountain path where the morning sun can be seen, autumnal tints, a smile of an occupant, or the like. In addition, the event detection unit 311 determines that an event is detected when the acquired position information coincides with pre-registered position information of a scenic spot, a popular spot, or the like. Examples of the scenic spot and the popular spot include a spot where the number of posts on an SNS (Social Networking Service) is a predetermined threshold or more. Further, the event detection unit 311 determines that an event is detected when the voice information includes laughter of the occupant or a specific keyword. Examples of the keyword include keywords reflecting impressions and excitement of the occupant, such as “The scenery is beautiful” or “It is a nice view”.

The information acquisition unit 312 acquires event related information related to the detected event. In the present embodiment, the moving image information photographed when the event is detected, the position information of the vehicle 2 when the event is detected, the voice information collected when the event is detected, weather information at an event detected position when the event is detected, and event detection date and time information are defined as the event related information.

Specifically, the information acquisition unit 312 acquires the photographed moving image information as the event related information from the front camera 21 and the monitor camera 22. The information acquisition unit 312 acquires the position information and the date and time information as the event related information from the GPS device 23. The information acquisition unit 312 acquires the voice information as the event related information from the microphone 24. In addition, by controlling the communication I/F 25, the information acquisition unit 312 acquires the weather information as the event related information via the communication network 5 from a weather server where the weather information is registered. An illustration of the weather server is omitted.

The tag creation unit 313 creates an editing tag based on the event related information. The editing tag is information used to create the content for which a moving image and music are combined. The tag creation unit 313 generates the editing tag for each of a plurality of content elements. Examples of the plurality of content elements include a moving image element and a music element.

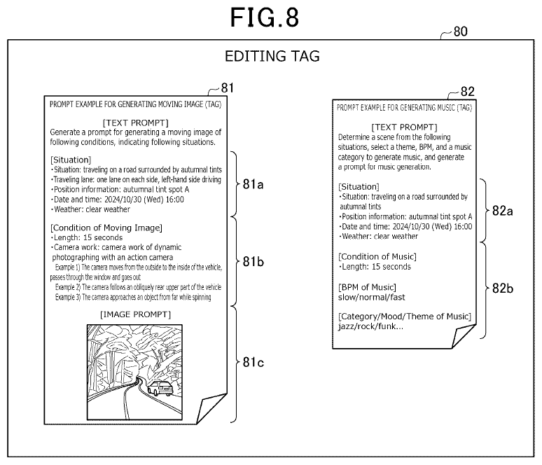

Here, the editing tag in Embodiment 1 will be described. FIG. 8 is an explanatory diagram illustrating a specific example of the editing tag in Embodiment 1.

An editing tag 80 is formed of a first element editing tag 81 and a second element editing tag 82. The first element editing tag 81 is an editing tag of the moving image element. The first element editing tag 81 is used to create a moving image. The second element editing tag 82 is an editing tag of the music element. The second element editing tag 82 is used to create music to be combined with the moving image to be created.

The first element editing tag 81 includes event text information 81a created based on the event related information, a moving image scenario 81b indicating a condition of the moving image to be created, and an event detection time photographed image 81c photographed when the event is detected. The photographed image 81c is a still image.

The text information 81a is information indicating in what situation the event is detected. For example, the text information 81a includes, as illustrated, information regarding the situation when the event is detected, a traveling lane, the position information, the date and time, and weather. The situation when the event is detected is created based on the photographed moving image information acquired from the front camera 21 and the monitor camera 22 and the voice information acquired from the microphone 24. The traveling lane is created based on the photographed moving image information acquired from the front camera 21 and the monitor camera 22. The position information and the date and time information are acquired from the GPS device 23. The weather information is acquired by controlling the communication I/F 25.

The moving image scenario 81b includes, as illustrated, information on a length of the moving image and camera work.

The second element editing tag 82 includes event text information 82a created based on the event related information, and a music scenario 82b indicating a condition of the music to be combined with the moving image.

The text information 82a includes, as illustrated, the information regarding the situation when the event is detected, the traveling lane, the position information, the date and time, and the weather. The text information 82a is the same information as the text information 81a.

The music scenario 82b includes, as illustrated, information on a length of the music, BPM (Beats Per Minute) of the music, and a category/mood/theme of the music. In the illustrated example, choices are registered for the BPM of the music and the category/mood/theme of the music, and are appropriately selected when the moving image is generated. The BPM of the music and the category/mood/theme of the music may be also selected when the music scenario 82b is created.

The editing tag is created in the in-vehicle device 3 and is transmitted to the information processing server 4. The information processing server 4 which has received the editing tag generates the moving image based on the details of the text information 81a, the details of the moving image scenario 81b, and the photographed image 81c when the event is detected. Note that, while the information processing server 4 generates the moving image using moving image generative AI in the present embodiment, the moving image may be created by combining moving image materials stored in the information processing server 4.

In addition, the information processing server 4 which has received the editing tag selects the BPM of the music and the category/mood/theme of the music in the music scenario 82b according to the details of the text information 82a, and generates the music according to the details of the text information 82a and the details of the music scenario 82b. Note that, while the music is generated using music generative AI in the present embodiment, the music may be created by combining stored music materials.

Here, the description will return to FIG. 2. The scenario creation unit 313a creates scenario information of the moving image based on the event related information. Specifically, the scenario creation unit 313a creates the moving image scenario 81b by inputting the text information 81a to a moving image scenario generation model that has been learned by machine learning. In addition, the scenario creation unit 313a creates the music scenario 82b by inputting the text information 82a to a music scenario generation model that has been learned by machine learning.

The transmission unit 314 transmits the editing tag created by the tag creation unit 313 to the information processing server 4.

The first memory 32 stores face photo information 322 as image information of face photos of the occupant, and vehicle model information 323 regarding a model of the vehicle 2. The face photo information 322 and the vehicle model information 323 are the information to be combined with the moving image created by the information processing server 4, and are sometimes referred to as composite information. The composite information is registered in the first memory 32 in advance.

The first communication device 33 is a communication device (transmitter/receiver, circuit) for the in-vehicle device 3 to communicate with the information processing server 4 and the terminal device 6 via the communication network 5.

### 3. Configuration of Information Processing Server

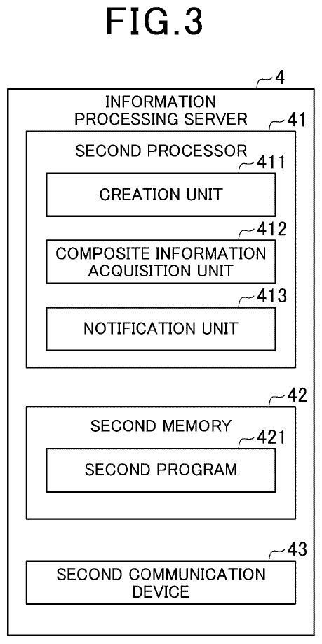

FIG. 3 is a diagram illustrating the configuration of the information processing server 4 in Embodiment 1. The information processing server 4 includes a second processor 41, a second memory 42, and a second communication device 43. The second memory 42 is formed of, for example, a nonvolatile semiconductor memory, or volatile and nonvolatile semiconductor memories. The second memory 42 may include an auxiliary storage device such as a hard disk device.

The second processor 41 is, for example, a computer provided with a CPU or the like. The second processor 41 may include a ROM in which a program is written and a RAM for temporary storage of data or the like. Then, as functional elements or functional units, the second processor 41 is provided with a creation unit 411, a composite information acquisition unit 412, and a notification unit 413.

These functional elements provided in the second processor 41 are realized by, for example, the second processor 41, which is a computer, executing a second program 421 preserved in the second memory 42. Note that the second program 421 can be stored in an arbitrary computer-readable storage medium. Alternatively, all or a part of the functional elements provided in the second processor 41 may be formed of hardware each including one or more electronic circuit components.

The creation unit 411 creates the content based on the editing tag received from the in-vehicle device 3. The content in the present embodiment includes the moving image element and the music element.

Specifically, the creation unit 411 generates the moving image by inputting the first element editing tag to an image generation model that has been learned by machine learning. In addition, the creation unit 411 generates the music by inputting the second element editing tag to a music generation model that has been learned by machine learning. Then, the creation unit 411 creates the content by combining the created moving image and the created music.

The composite information acquisition unit 412 acquires at least one of the vehicle model information 323 and the face photo information 322.

Further, the creation unit 411 creates the moving image based on the scenario information of the moving image, and combines an image based on the composite information acquired by the composite information acquisition unit 412 with the created moving image. The image based on the composite information is the image adjusted to be combined with the created moving image.

The second communication device 43 is a communication device (transmitter/receiver, circuit) for the information processing server 4 to communicate with the in-vehicle device 3 and the terminal device 6 via the communication network 5.

### 4. Configuration of Terminal Device

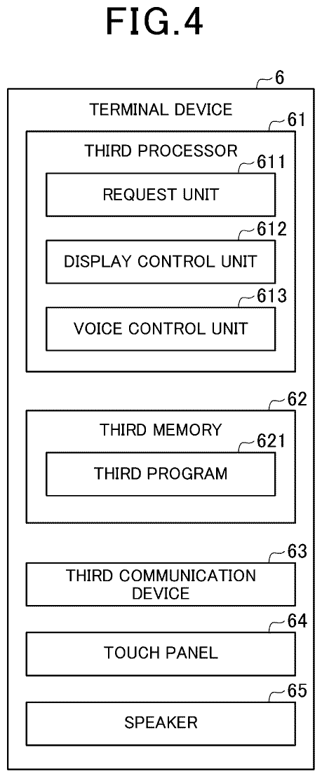

FIG. 4 is a diagram illustrating the configuration of the terminal device 6 in Embodiment 1. The terminal device 6 includes a third processor 61, a third memory 62, a third communication device 63, a touch panel 64, and a speaker 65. The third memory 62 is formed of, for example, a nonvolatile semiconductor memory, or volatile and nonvolatile semiconductor memories. The third memory 62 may include an auxiliary storage device such as a hard disk device.

The third processor 61 is, for example, a computer provided with a CPU or the like. The third processor 61 may include a ROM in which a program is written and a RAM for temporary storage of data or the like. Then, as functional elements or functional units, the third processor 61 is provided with a request unit 611, a display control unit 612, and a voice control unit 613.

These functional elements provided in the third processor 61 are realized by, for example, the third processor 61, which is a computer, executing a third program 621 preserved in the third memory 62. Note that the third program 621 can be stored in an arbitrary computer-readable storage medium. Alternatively, all or a part of the functional elements provided in the third processor 61 may be formed of hardware each including one or more electronic circuit components.

The request unit 611 transmits a content downloading request to the information processing server 4.

The display control unit 612 controls display of the touch panel 64. The touch panel 64 is a display (display device) for which a touch sensor is disposed on a surface of a flat panel display.

The voice control unit 613 controls voice output of the speaker 65.

The third communication device 63 is a communication device (transmitter/receiver, circuit) for the terminal device 6 to communicate with the in-vehicle device 3 and the information processing server 4 via the communication network 5.

### 5. Operation of In-Vehicle Device

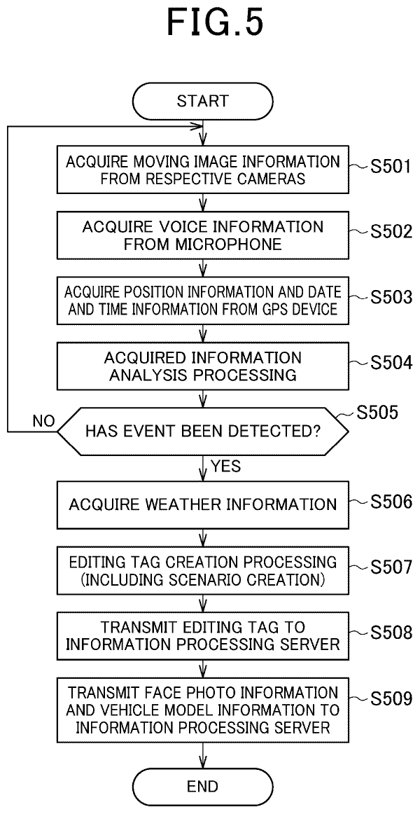

Next, a procedure of first processing performed by the in-vehicle device 3 will be described. The in-vehicle device 3 executes the first processing illustrated in FIG. 5.

FIG. 5 is a flowchart illustrating the first processing performed by the in-vehicle device 3 in Embodiment 1. In the first processing illustrated in FIG. 5, the information acquisition unit 312 of the first processor 31 acquires the moving image information photographed by the respective cameras (the front camera 21 and the monitor camera 22) from the respective cameras (step S501). The information acquisition unit 312 of the first processor 31 acquires the voice information collected by the microphone 24 from the microphone 24 (step S502). The information acquisition unit 312 of the first processor 31 acquires the position information of the vehicle 2 and the date and time information acquired by the GPS device 23 from the GPS device 23 (step S503).

The event detection unit 311 of the first processor 31 analyzes the information acquired in steps S501 to S503 (step S504), and determines presence/absence of event detection (step S505).

Specifically, the event detection unit 311 determines whether or not specific conditions are satisfied, that is, whether or not an event has been detected, by image-analyzing the photographed image inside and outside the vehicle, which is acquired in step S501. In the present embodiment, for example, one of the specific conditions is that the photographed image outside the vehicle includes scenery of the sea at dusk, a mountain path where the morning sun can be seen, autumnal tints, or the like. In addition, for example, one of the specific conditions is that the photographed image inside the vehicle includes a smile of the occupant.

Further, the event detection unit 311 determines whether or not specific conditions are satisfied, that is, whether or not an event has been detected, by voice-analyzing the voice information inside the vehicle, which is acquired in step S502. In the present embodiment, for example, one of the specific conditions is that the voice information is analyzed and made into text and the laughter of the occupant or the specific keyword is included in the text. Examples of the keyword include keywords reflecting impressions and excitement of the occupant such as “The scenery is beautiful” or “It is a nice view”.

In addition, the event detection unit 311 determines whether or not specific conditions are satisfied, that is, whether or not an event has been detected, by analyzing the position information of the vehicle 2 acquired in step S503. In the present embodiment, for example, one of the specific conditions is that the acquired position information is compared with the pre-registered position information of a scenic spot or a popular spot and they coincide with each other. Examples of the scenic spot and the popular spot include a spot where the number of posts on the SNS is a predetermined threshold or more.

In step S505, the event detection unit 311 determines that an event has been detected when one of these specific conditions is satisfied. When an event is not detected, the first processor 31 shifts to step S501. At that time, the first processor 31 discards the information acquired in steps S501 to S503, however, it may be stored for a fixed period.

When an event is detected, the information acquisition unit 312 of the first processor 31 acquires the weather information as the event related information from the weather server via the communication network 5 by controlling the communication I/F 25 (step S506). The weather information acquired here is the weather information according to the position information and the date and time information acquired in step S503. That is, it is the weather information according to the location and the date and time of event occurrence.

The first processor 31 performs editing tag creation processing of creating an editing tag including a scenario (step S507).

The editing tag creation processing includes first editing tag creation processing of creating the first element editing tag and second editing tag creation processing of creating the second element editing tag.

In the first editing tag creation processing, the first processor 31 first creates the text information 81a based on each information acquired in steps S501 to S503 and S506. Next, the first processor 31 inputs the created text information 81a to the moving image scenario generation model and registers the output as the moving image scenario 81b. Finally, the first processor 31 creates the event detection time photographed image 81c by creating (extracting) a still image from the moving image information acquired in step S501.

In the second editing tag creation processing, the first processor 31 first registers the text information 81a of the first element editing tag created in the first editing tag creation processing as the text information 82a of the second element editing tag. Next, the first processor 31 inputs the registered text information 82a to the music scenario generation model and registers the output as the music scenario 82b.

The transmission unit 314 transmits the created editing tag to the information processing server 4 (step S508). Further, the transmission unit 314 transmits the face photo information 322 and the vehicle model information 323 to the information processing server 4 (step S509). Note that the transmission unit 314 is configured to transmit the face photo information 322 and the vehicle model information 323 to the information processing server 4 every time an event is detected in the present embodiment, however, it is not limited thereto. For example, the transmission unit 314 may be configured, after transmitting the face photo information 322 and the vehicle model information 323 to the information processing server 4 once, not to transmit the face photo information 322 and the vehicle model information 323 to the information processing server 4 when an event is detected and to retransmit the face photo information 322 and the vehicle model information 323 to the information processing server 4 when they are updated.

### 6. Operation of Information Processing Server

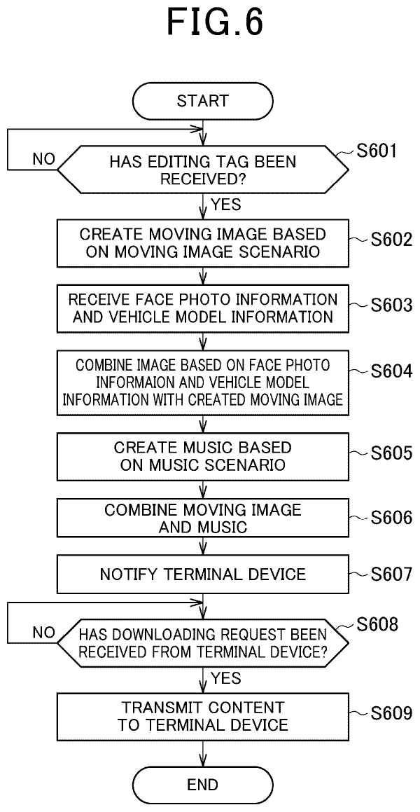

Next, a procedure of second processing performed by the information processing server 4 will be described. The information processing server 4 executes the second processing illustrated in FIG. 6.

FIG. 6 is a flowchart illustrating the second processing performed by the information processing server 4 in Embodiment 1. In the second processing illustrated in FIG. 6, the second processor 41 determines whether or not the editing tag has been received from the in-vehicle device 3 and stands by until it is received (step S601). When the editing tag is received from the in-vehicle device 3, the creation unit 411 creates the moving image based on the received editing tag (step S602).

In step S602, the creation unit 411 generates the moving image by inputting the first element editing tag to the image generation model that has been learned by machine learning.

The composite information acquisition unit 412 receives the face photo information 322 and the vehicle model information 323 from the in-vehicle device 3 (step S603).

The creation unit 411 performs processing of combining images based on the received face photo information 322 and vehicle model information 323 with the moving image created in step S602 (step S604). Specifically, as the image based on the face photo information 322, the creation unit 411 creates a face image by removing a background or the like from the received face photo information 322 and combines it so as to replace a face image of a person appearing in the moving image. In addition, as the image based on the vehicle model information 323, the creation unit 411 extracts a vehicle body image stored in the second memory 42 in association with the vehicle model and combines it so as to replace the vehicle appearing in the moving image with the extracted vehicle body image.

The creation unit 411 creates music based on the music scenario included in the received editing tag (step S605). In step S605, the creation unit 411 generates the music by inputting the second element editing tag to the music generation model that has been learned by machine learning.

The creation unit 411 creates the content by combining the moving image combined in step S604 and the music created in step S605 (step S606).

The notification unit 413 notifies the terminal device 6 that the content has been created (step S607).

The second processor 41 determines whether or not a downloading request for created content data has been received from the terminal device 6 (step S608). If the downloading request has been received, the second processor 41 transmits the content data to the terminal device 6 (step S609).

### 7. Operation of Terminal Device

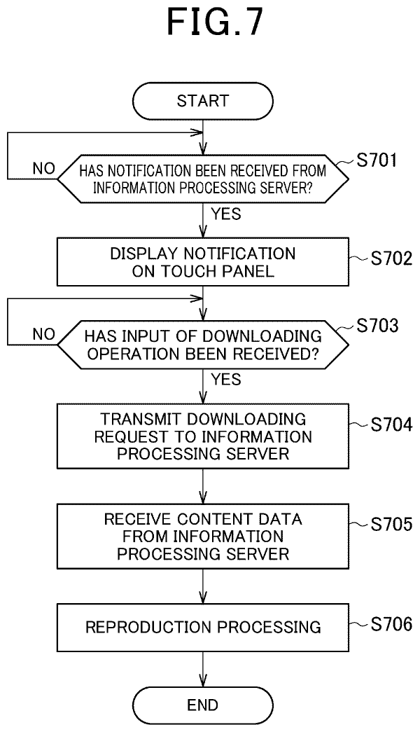

Next, a procedure of third processing performed by the terminal device 6 will be described. The terminal device 6 executes the third processing illustrated in FIG. 7.

FIG. 7 is a flowchart illustrating the third processing performed by the terminal device 6 in Embodiment 1. In the third processing illustrated in FIG. 7, the third processor 61 determines whether or not a notification that the content has been created has been received from the information processing server 4, and stands by until it is received (step S701). When the notification that the content has been created is received from the information processing server 4, the display control unit 612 displays information indicating the notification on the touch panel 64 (step S702).

The third processor 61 determines whether or not a downloading operation that instructs content downloading has been input to the touch panel 64 (step S703). If the downloading operation has been input to the touch panel 64, the request unit 611 transmits a content downloading request to the information processing server 4 (step S704).

Thereafter, the third processor 61 stands by until the content data is received from the information processing server 4 (step S705). When the content data is received, the display control unit 612 and the voice control unit 613 perform reproduction processing of reproducing the received content. Thus, the content is reproduced using the touch panel 64 and the speaker 65 (step S706).

As described above, in Embodiment 1, the information processing system 1 includes the event detection unit 311 configured to detect the occurrence of an event inside and outside the vehicle 2, the information acquisition unit 312 configured to acquire the event related information related to the event, the tag creation unit 313 configured to create the editing tag based on the event related information, and the creation unit 411 configured to create the content based on the editing tag.

Thus, for example, compared to the configuration in which a server receives material data (the moving image, the voice) of content, edits the received data, and creates the content, content editing time can be shortened while suppressing a communication cost. Therefore, in a content creation service, since the communication cost is suppressed and the content editing time is shortened, marketability can be improved.

In addition, in Embodiment 1, the event detection unit 311 may detect the occurrence of an event based on at least one of the photographed moving image information acquired from cameras (the front camera 21, the monitor camera 22) that photograph the inside and outside of the vehicle 2, the position information acquired from the GPS device 23 that acquires the position information of the vehicle 2, and the voice information acquired from the microphone 24 that collects voice inside and outside the vehicle 2.

Thus, an event can be detected based on the plurality of pieces of information. Therefore, the content can be created according to a user's needs, and the marketability can be improved. For example, in the present embodiment, even if the photographed moving image information does not satisfy the specific condition, the occurrence of an event is detected when the voice information includes the keyword reflecting the impression and excitement of the occupant. Therefore, the event more suitable for the user's preference can be detected.

Further, in Embodiment 1, the content may include the plurality of content elements and the tag creation unit 313 may generate the editing tag for each of the plurality of content elements.

Thus, the processing of creating the content from the editing tag can be divided for each content element. Therefore, processing burdens can be reduced.

In addition, in Embodiment 1, the plurality of content elements may include the moving image element and the music element, and the creation unit 411 may create the first element editing tag 81 including at least one of the event text information 81a created based on the event related information, the moving image scenario 81b, and the photographed image 81c photographed when the event is detected, as the editing tag of the moving image element, and may create the second element editing tag 82 including at least one of the event text information 82a created based on the event related information and the music scenario 82b to be combined with the moving image, as the editing tag of the music element.

Thus, since the content is created from the editing tag 80 including the text information 81a, the moving image scenario 81b, and the music scenario 82b, for example, compared to the case of creating the content based on the material data (moving image data, music data), the processing burdens when creating the content can be suppressed. Therefore, content generation time is shortened and the marketability can be improved.

Note that the editing tag including the first element editing tag used to create the moving image element in the content and the second element editing tag used to create the music element in the content is created in the present embodiment, however, it is not limited thereto. For example, a vibrator of a reproduction device may be vibrated in accordance with the moving image and the music in the content, and in that case, an editing tag including a vibration element editing tag used to create a vibration element in the content may be provided. In addition, for example, a scent may be generated from the reproduction device in accordance with the moving image and the music in the content, and in that case, an editing tag including a scent element editing tag used to create a scent element in the content may be provided.

In addition, in Embodiment 1, the information processing system 1 may include the vehicle 2 and the information processing server 4 that can communicate with the vehicle 2, the vehicle 2 may include the tag creation unit 313 and the transmission unit 314 configured to transmit the editing tag 80 to the information processing server 4, the information processing server 4 may include the creation unit 411 and the composite information acquisition unit 412 configured to acquire at least one of the vehicle model information 323 and the face photo information 322, the tag creation unit 313 may include the scenario creation unit 313a configured to create the moving image scenario 81b based on the event related information, the creation unit 411 may create the moving image based on the moving image scenario 81b, and the image based on the information acquired by the composite information acquisition unit 412 may be combined with the created moving image.

Thus, the moving image can be created based on at least one of the vehicle model information 323 and the face photo information 322. Therefore, the moving image according to the user's needs can be created, and the marketability can be improved.

Note that, while the composite information acquisition unit 412 acquires both of the vehicle model information 323 and the face photo information 322 in the present embodiment, the composite information acquisition unit 412 may acquire either one of the information.

In addition, while the composite information acquisition unit 412 acquires at least one of the vehicle model information 323 and the face photo information 322 from the in-vehicle device 3 in the present embodiment, it may be acquired from another device. For example, the composite information acquisition unit 412 may acquire at least one of the vehicle model information 323 and the face photo information 322 from the terminal device 6.

Further, the vehicle model information 323 as vehicle information and the face photo information 322 as occupant information may be edited and processed by editing software in advance. In addition, the vehicle model information 323 as the vehicle information and the face photo information 322 as the occupant information are not limited to the photographed images themselves or processed images based on the photographed images. For example, an imaginary person such as a fictional character may be used as the occupant information, or an imaginary vehicle may be used as the vehicle information. In such a manner, by registering the occupant information and the vehicle information to be combined in advance, the content according to the user's preference can be created.

In addition, the image based on the vehicle model information 323 is combined with the created moving image in the present embodiment, however, it is not limited thereto. For example, an image based on custom information regarding a color and accessories of the vehicle registered in advance may be combined.

Further, the vehicle information is not limited to the information of the vehicle that the user owns and may be the information of a vehicle different from the vehicle that the user owns. For example, by registering a vehicle model according to the user's preference as the vehicle information in advance, the moving image in which the vehicle of the model according to the user's preference appears can be created.

Note that, while the information processing server 4 creates the content using the editing tag in the present embodiment, the in-vehicle device 3 may perform both the creation of the editing tag and the creation of the content using the created editing tag.

Note that the in-vehicle device 3 determines the presence/absence of the event detection when information for determining the presence/absence of the event occurrence is received in the present embodiment, however, it is not limited thereto. Here, the information for determining the presence/absence of the event occurrence is the information acquired in steps S501 to S503. Hereinafter, the information for determining the presence/absence of the event occurrence is referred to as event determination information. For example, if the event occurrence has not been detected (NO in step S505), the in-vehicle device 3 may store the event determination information and determine the event occurrence based on the stored event determination information at any of the following timings.

When updating software corresponding to a function of the event detection unit 311, a condition for an event to be detected is added, and the in-vehicle device 3 may determine whether or not the past event determination information satisfies the additional condition at the timing after an update.

In addition, the event detection unit 311 may have a learning function for learning under what condition the occupant has gotten excited or impressed, update an event detection condition based on a learning result, and detect the event occurrence from the past event determination information. Specifically, the event detection unit 311 may have a learning function for learning under what condition the voice information has included the laughter of the occupant or the specific keyword.

Further, the in-vehicle device 3 may acquire latest trend information from another system, register position information corresponding to the trend information as a new event detection condition, and determine the event detection based on the new event detection condition from the past event determination information. Examples of another system include an SNS server.

In this way, the information processing system 1 in Embodiment 1 is configured to create the respective scenarios (the moving image scenario, the music scenario) when creating the editing tag by the in-vehicle device 3 and to generate the content according to the respective scenarios using the generative AI by the information processing server 4. However, the configuration of the information processing system 1 is not limited thereto. For example, the information processing system 1 may be configured to create the editing tag by the in-vehicle device 3, to create the respective scenarios based on the editing tag by the information processing server 4, and to create the content according to the respective scenarios by combining the material data by the information processing server 4.

### Embodiment 2

Next, Embodiment 2 will be described. Note that only points different from the embodiment described above will be described hereinafter, and the description is omitted for the points same as the embodiment described above.

### 8. Configuration of Vehicle

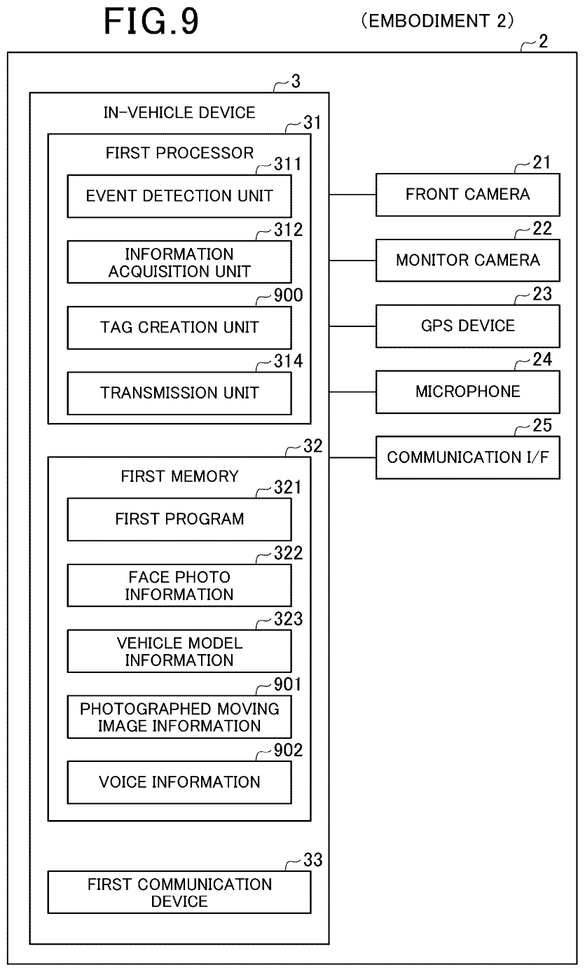

FIG. 9 is a diagram illustrating the configuration of the vehicle 2 in Embodiment 2.

As functional elements or functional units, the first processor 31 is provided with the event detection unit 311, the information acquisition unit 312, a tag creation unit 900, and the transmission unit 314. These functional elements provided in the first processor 31 are realized by, for example, the first processor 31, which is a computer, executing the first program 321 preserved in the first memory 32.

The tag creation unit 900 creates the editing tag based on the event related information. The tag creation unit 900 in Embodiment 2 does not create scenarios.

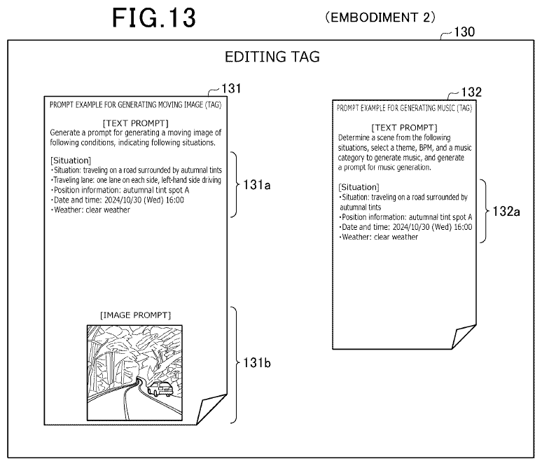

Here, the editing tag in Embodiment 2 will be described. FIG. 13 is an explanatory diagram illustrating a specific example of the editing tag in Embodiment 2.

An editing tag 130 is formed of a first element editing tag 131 and a second element editing tag 132. The first element editing tag 131 is an editing tag of the moving image element. The first element editing tag 131 is used to create a moving image. The second element editing tag 132 is an editing tag of the music element. The second element editing tag 132 is used to create music to be combined with the moving image to be created.

The first element editing tag 131 includes event text information 131a created based on the event related information, and an event detection time photographed image 131c photographed when the event is detected.

The text information 131a includes, as illustrated, information regarding the situation when the event is detected, the traveling lane, the position information, the date and time, and the weather.

The second element editing tag 132 includes event text information 132a created based on the event related information.

The text information 132a includes, as illustrated, the information regarding the situation when the event is detected, the traveling lane, the position information, the date and time, and the weather.

Here, the description will return to FIG. 9. The first memory 32 stores, in addition to the first program 321, the face photo information 322, the vehicle model information 323, photographed moving image information 901, and voice information 902. The photographed moving image information 901 is the moving image information photographed by the respective cameras (the front camera 21 and the monitor camera 22), and is the moving image information acquired in step S501. The voice information 902 is the voice information collected by the microphone 24, and is the voice information acquired in step S502.

### 9. Configuration of Information Processing Server

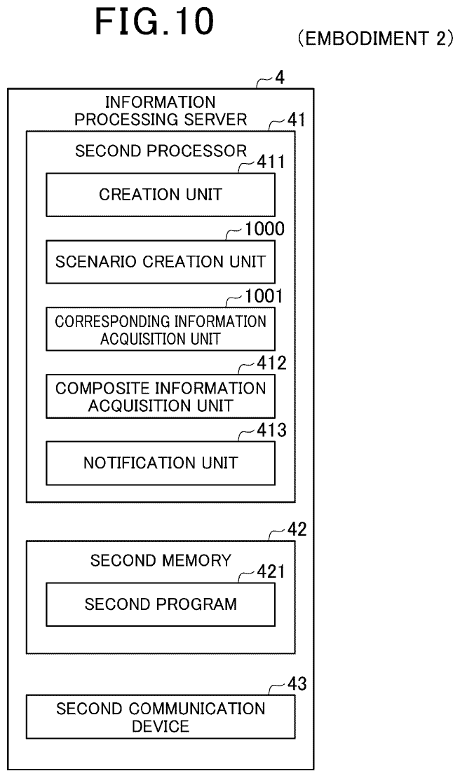

FIG. 10 is a diagram illustrating the configuration of the information processing server 4 in Embodiment 2. As functional elements or functional units, the second processor 41 is provided with the creation unit 411, the composite information acquisition unit 412, the notification unit 413, a scenario creation unit 1000, and a corresponding information acquisition unit 1001. These functional elements provided in the second processor 41 are realized by, for example, the second processor 41, which is a computer, executing the second program 421 preserved in the second memory 42.

The scenario creation unit 1000 creates the scenario information of the moving image and the scenario information of the music to be combined with the moving image based on the event text information.

The corresponding information acquisition unit 1001 acquires the moving image information and the voice information inside and outside the vehicle 2 corresponding to the scenario information of the moving image and the scenario information of the music. Specifically, the corresponding information acquisition unit 1001 acquires the photographed moving image information corresponding to the scenario information of the moving image out of the photographed moving image information 901 and acquires the voice information corresponding to the scenario information of the music out of the voice information 902, from the in-vehicle device 3. The information corresponding to each scenario information is sometimes referred to as corresponding information.

The information corresponding to the scenario information of the moving image is the information required to create the moving image according to the scenario of the moving image. For example, when traveling through the scenery of autumnal tints is detected as an event and the scenario information of the moving image includes a condition of “camera work that dynamically photographs the autumnal tints”, an image of the autumnal tints acquired from the front camera 21 corresponds to the information corresponding to the scenario information of the moving image. In addition, for example, when the inside of the vehicle getting lively is detected as an event and the scenario information of the moving image includes a condition of “camera work that zooms and photographs a smile of the occupant”, a smile image of the occupant acquired from the monitor camera 22 corresponds to the information corresponding to the scenario information of the moving image.

The information corresponding to the scenario information of the music is the information required to create the music (voice) according to the scenario of the music. For example, when the inside of the vehicle getting lively is detected as an event and the music scenario includes a condition of “including a lot of laughter”, the laughter of the occupant acquired from the microphone 24 corresponds to the information corresponding to the scenario information of the music.

### 10. Operation of In-Vehicle Device

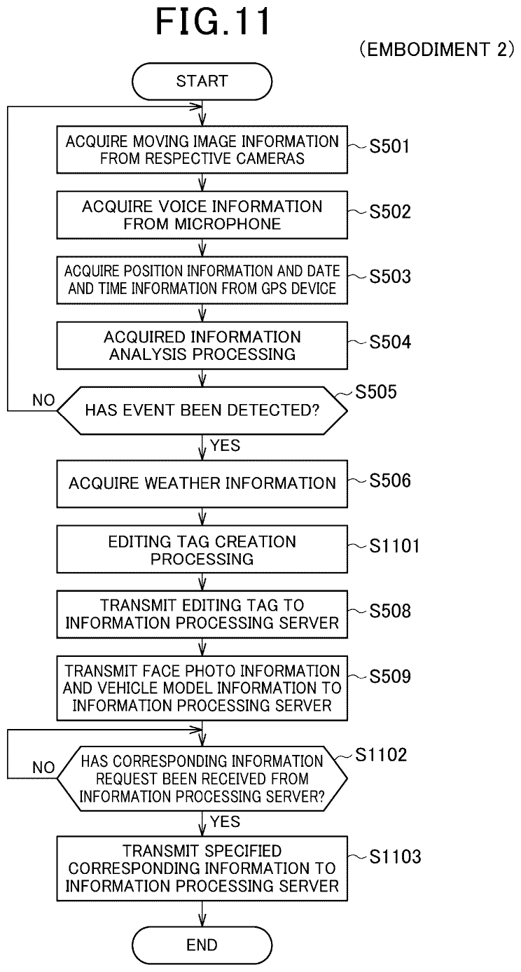

FIG. 11 is a flowchart illustrating the first processing performed by the in-vehicle device 3 in Embodiment 2. In the first processing in Embodiment 2, the tag creation unit 900 of the first processor 31 performs the editing tag creation processing (step S1101) after step S506. At that time, the tag creation unit 900 does not create a moving image scenario and a music scenario.

In addition, after step S509, the first processor 31 determines whether or not a corresponding information request has been received from the information processing server 4 (step S1102). If the corresponding information request has been received, the first processor 31 transmits the corresponding information specified in the corresponding information request to the information processing server 4 (step S1103). The corresponding information is, for example, the photographed moving image information corresponding to the scenario information of the moving image from the photographed moving image information 901 or the voice information corresponding to the scenario information of the music from the voice information 902.

### 11. Operation of Information Processing Server

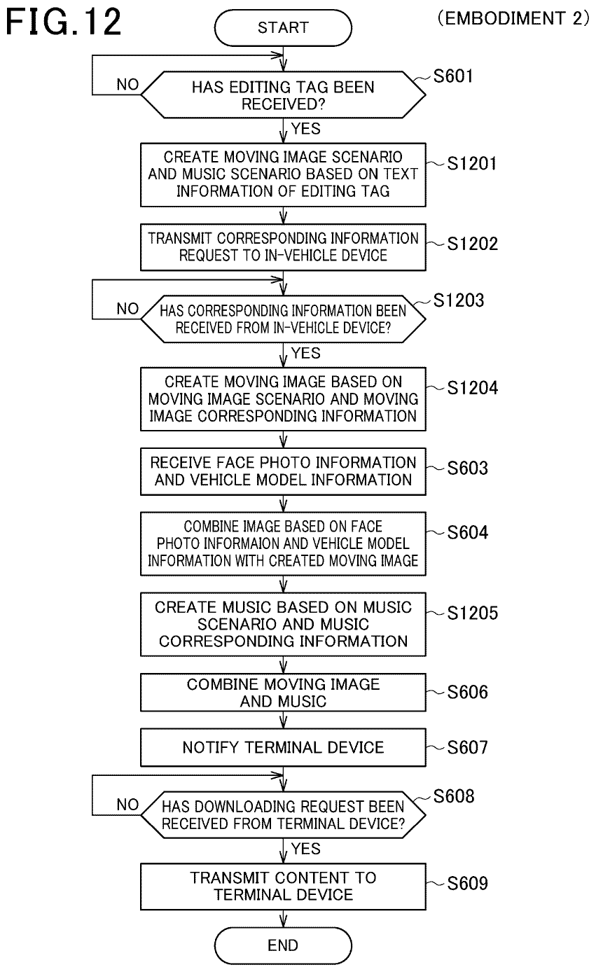

FIG. 12 is a flowchart illustrating the second processing performed by the information processing server 4 in Embodiment 2. In the second processing in Embodiment 2, if the editing tag has been received in step S601, the scenario creation unit 1000 of the second processor 41 creates the moving image scenario and the music scenario based on the text information of the received editing tag (step S1201).

Specifically, the scenario creation unit 1000 inputs text information 131a in the received editing tag to the moving image scenario generation model and registers the output as the moving image scenario. In addition, the scenario creation unit 1000 inputs text information 132a in the received editing tag to the music scenario generation model and registers the output as the music scenario.

The second processor 41 transmits, to the in-vehicle device 3, a request to acquire the corresponding information of the moving image required to create the moving image according to the moving image scenario and the corresponding information of the music required to create the music according to the music scenario (step S1202).

The second processor 41 determines whether or not the respective pieces of corresponding information (the moving image information, the voice information) have been received from the in-vehicle device 3 (step S1203). If the respective pieces of corresponding information (the moving image information, the voice information) have been received from the in-vehicle device 3, the creation unit 411 creates the moving image based on the moving image scenario and the received moving image corresponding information (step S1204). Thereafter, the second processor 41 shifts to step S603.

After step S604, the creation unit 411 of the second processor 41 creates the music based on the music scenario and the received music corresponding information (step S1205). Thereafter, the second processor 41 shifts to step S606.

As described above, in Embodiment 2, the tag creation unit 900 creates the first element editing tag 131 including at least one of the event text information 131a created based on the event related information and the photographed image 131b photographed when the event is detected, and creates the second element editing tag 132 including the event text information 132a created based on the event related information.

Thus, since the content is created from the editing tag 130 including the text information 131a, for example, compared to the case of creating the content based on the material data (moving image data, music data), the processing burdens when creating the content can be suppressed. Therefore, the content generation time is shortened and the marketability can be improved.

In addition, in Embodiment 2, the information processing system 1 may include the vehicle 2 and the information processing server 4 that can communicate with the vehicle 2, the vehicle 2 may include the transmission unit 314 configured to transmit the editing tag to the information processing server 4, the information processing server 4 may include the creation unit 411, the scenario creation unit 1000 configured to create the scenario information of the moving image and the scenario information of the music to be combined with the moving image based on the event text information, and the corresponding information acquisition unit 1001 configured to acquire the photographed moving image information 901 and the voice information 902 inside and outside the vehicle 2 corresponding to the scenario information of the moving image and the scenario information of the music, and the creation unit 411 may create the content based on the scenario information of the moving image, the scenario information of the music, and the photographed moving image information 901 and the voice information 902 inside and outside the vehicle 2 acquired by the corresponding information acquisition unit 1001.

Thus, since the information processing server 4 creates the content by creating the moving image scenario and the music scenario and acquiring only required data, for example, compared to the configuration of creating the content by acquiring all the moving image information photographed by the respective cameras (the front camera 21 and the monitor camera 22) and all the voice information collected by the microphone 24, content editing loads can be suppressed while suppressing the communication cost. Therefore, in the content creation service, since the communication cost is suppressed and content creation time is shortened, the marketability can be improved.

Note that the information processing server 4 acquires the photographed moving image information 901 photographed by the respective cameras (the front camera 21 and the monitor camera 22) and the voice information 902 collected by the microphone 24 as the moving image information and the voice information inside and outside the vehicle corresponding to the moving image scenario information and the music scenario information in Embodiment 2, however, it is not limited thereto. For example, the information processing server 4 may acquire the moving image photographed by a camera of the terminal device 6 when the event is detected and the voice information collected by a microphone of the terminal device 6 when the event is detected as the moving image information and the voice information inside and outside the vehicle corresponding to the moving image scenario information and the music scenario information, and create the content based on the acquired information.

Further, if a moving image photographed by a camera provided on a road can be acquired from an external device, the information processing server 4 may transmit the date and time information and the position information when the event is detected to the external device, acquire the moving image associated with the date and time information and the position information from the external device, and create the content based on the acquired moving image.

In addition, the information processing server 4 may be able to acquire, from a drive recorder provided in another vehicle different from the vehicle 2, other vehicle information acquired by the drive recorder, and create the content based on the acquired other vehicle information. Examples of the other vehicle information include moving image information acquired from a camera of the drive recorder and voice information acquired from a microphone of the drive recorder. For example, the other vehicle information is transmitted from the drive recorder of another vehicle to a terminal device of another vehicle that a user of another vehicle can operate, and the other vehicle information is transmitted from the terminal device of another vehicle to the information processing server 4. Then, the information processing server 4 may create the content based on the received other vehicle information. Note that it is desirable that the user of another vehicle has permitted sharing the other vehicle information via the terminal device of another vehicle in advance. Thus, for example, a following vehicle photographs a moving image in which a preceding vehicle is an object in a situation of touring and the photographed moving image can be used to create the content in the preceding vehicle.

Further, in Embodiment 2, the information processing system 1 may include the vehicle 2 and the information processing server 4 that can communicate with the vehicle 2, the vehicle 2 may include the transmission unit 314 configured to transmit the editing tag to the information processing server 4, the information processing server 4 may include the creation unit 411, the scenario creation unit 1000 configured to create the scenario information of the moving image based on the event text information, the corresponding information acquisition unit 1001 configured to acquire the moving image inside and outside the vehicle 2 corresponding to the scenario information of the moving image, and the composite information acquisition unit 412 configured to acquire at least one of the vehicle model information 323 and the face photo information 322, and the creation unit 411 may create the moving image based on the scenario information of the moving image and the moving image inside and outside the vehicle 2 acquired by the corresponding information acquisition unit 1001, and combine the image based on the information acquired by the composite information acquisition unit 412 with the created moving image.

Thus, since the information processing server 4 creates the content by creating the moving image scenario and the music scenario and acquiring only required data, for example, compared to the configuration of creating the content by acquiring all the moving image information photographed by the respective cameras (the front camera 21 and the monitor camera 22) and all the voice information collected by the microphone 24, the content editing loads can be suppressed while suppressing the communication cost. Therefore, in the content creation service, since the communication cost is suppressed and the content creation time is shortened, the marketability can be improved.

In addition, thus, the moving image can be created based on the vehicle model information 323 and the face photo information 322. Therefore, the moving image according to the user's needs can be created, and the marketability can be improved.

Note that the information processing server 4 may be able to combine an image different from the image based on the occupant information and the vehicle information. For example, when the background of the photographed moving image information acquired by the information processing server 4 as the corresponding information of the moving image is rainy weather or cloudy weather, the moving image of clear weather may be combined with the created content. In addition, for example, when the scenery of the photographed moving image information acquired by the information processing server 4 as the corresponding information of the moving image does not satisfy the specific condition (that the photographed moving image information includes a scenery image of the sea at dusk, a mountain path where the morning sun can be seen, autumnal tints, or the like, for example), an image satisfying the specific condition may be combined with the created content. Specifically, when the position information acquired by the in-vehicle device 3 coincides with the position of a scenic spot famous for the sea at dusk and thus an event is detected, the sea at dusk may not be beautifully included in the photographed moving image information acquired when the event is detected because an obstacle is present. Examples of the obstacle include other vehicles and a construction site. In such a case, an image of the sea at dusk may be combined.

### 12. Configurations Supported by Embodiments Described Above

The embodiments described above support the following configurations.

(Configuration 1) An information processing system including: an event detection unit configured to detect occurrence of an event inside and outside a vehicle; an information acquisition unit configured to acquire event related information related to the event; a tag creation unit configured to create an editing tag based on the event related information; and a creation unit configured to create content based on the editing tag.

According to the information processing system of configuration 1, the content editing time can be shortened while suppressing the communication cost. Therefore, in the content creation service, since the communication cost is suppressed and the content editing time is shortened, the marketability can be improved.

(Configuration 2) The information processing system according to configuration 1, wherein the event detection unit detects the occurrence of an event based on at least one of photographed moving image information acquired from a camera that photographs inside and outside of the vehicle, position information acquired from a position information acquisition device that acquires position information of the vehicle, and voice information acquired from a microphone that collects voice inside and outside the vehicle.

According to the information processing system of configuration 2, the event can be detected based on the plurality of pieces of information. Therefore, the content can be created according to the user's needs, and the marketability can be improved.

(Configuration 3) The information processing system according to configuration 2, wherein the content includes a plurality of content elements, and the tag creation unit generates the editing tag for each of the plurality of content elements.

According to the information processing system of configuration 3, the processing of creating the content from the editing tag can be divided for each content element. Therefore, the processing burdens can be reduced.

(Configuration 4) The information processing system according to configuration 3, wherein the plurality of content elements include a moving image element and a music element, and the creation unit creates a first element editing tag including at least one of text information of the event, the text information being created based on the event related information, scenario information of a moving image, and image information photographed when the event is detected, as an editing tag of the moving image element, and creates a second element editing tag including at least one of text information of the event, the text information being created based on the event related information, and scenario information of music to be combined with the moving image, as an editing tag of the music element.

According to the information processing system of configuration 4, processing loads when creating the content can be suppressed. Therefore, the content generation time is shortened and the marketability can be improved.

(Configuration 5) The information processing system according to configuration 4, including the vehicle and an information processor that can communicate with the vehicle, wherein the vehicle includes the tag creation unit and a transmission unit configured to transmit the editing tag to the information processor, the information processor includes the creation unit and a composite information acquisition unit configured to acquire at least one of vehicle information and occupant information, the tag creation unit includes a scenario creation unit configured to create scenario information of the moving image based on the event related information, and the creation unit creates the moving image based on the scenario information of the moving image, and combines an image based on the information acquired by the composite information acquisition unit with the created moving image.

According to the information processing system of configuration 5, the moving image can be created based on at least one of the vehicle information and the occupant information. Therefore, the moving image can be created according to the user's needs, and the marketability can be improved.

(Configuration 6) The information processing system according to configuration 3, wherein the plurality of content elements include a moving image element and a music element, and the creation unit creates a first element editing tag including at least one of text information of the event, the text information being created based on the event related information, and image information photographed when the event is detected, as an editing tag of the moving image element, and creates a second element editing tag including text information of the event, the text information being created based on the event related information, as an editing tag of the music element.

According to the information processing system of configuration 6, the processing loads when creating the content can be suppressed. Therefore, the content generation time is shortened and the marketability can be improved.

(Configuration 7) The information processing system according to configuration 6, including the vehicle and an information processor that can communicate with the vehicle, wherein the vehicle includes a transmission unit configured to transmit the editing tag to the information processor, the information processor includes the creation unit, a scenario creation unit configured to create scenario information of a moving image and scenario information of music to be combined with the moving image based on text information of the event, and a corresponding information acquisition unit configured to acquire the moving image information and the voice information inside and outside the vehicle corresponding to the scenario information of the moving image and the scenario information of the music, and the creation unit creates the content based on the scenario information of the moving image, the scenario information of the music, and the moving image information and the voice information inside and outside the vehicle, the moving image information and the voice information being acquired by the corresponding information acquisition unit.

According to the information processing system of configuration 7, the content editing loads can be suppressed while suppressing the communication cost. Therefore, in the content creation service, since the communication cost is suppressed and the content creation time is shortened, the marketability can be improved.

(Configuration 8) The information processing system according to configuration 6, including the vehicle and an information processor that can communicate with the vehicle, wherein the vehicle includes a transmission unit configured to transmit the editing tag to the information processor, the information processor includes the creation unit, a scenario creation unit configured to create scenario information of a moving image based on text information of the event, a corresponding information acquisition unit configured to acquire the moving image inside and outside the vehicle corresponding to the scenario information of the moving image, and a composite information acquisition unit configured to acquire at least one of vehicle information and occupant information, and the creation unit creates the moving image based on the scenario information of the moving image and the moving image inside and outside the vehicle, the moving image being acquired by the corresponding information acquisition unit, and combines an image based on the information acquired by the composite information acquisition unit with the created moving image.

According to the information processing system of configuration 8, the content editing loads can be suppressed while suppressing the communication cost. Therefore, in the content creation service, since the communication cost is suppressed and the content creation time is shortened, the marketability can be improved.

(Configuration 9) An information processing method executed by a computer of an information processing system, the method including: an event detection step of detecting occurrence of an event inside and outside a vehicle; an information acquisition step of acquiring event related information related to the event; a tag creation step of creating an editing tag based on the event related information; and a creation step of creating content based on the editing tag.

According to the information processing method of configuration 9, effects similar to that of the information processing system of configuration 1 are accomplished.

### REFERENCE SIGNS LIST

1 . . . information processing system, 2 . . . vehicle, 3 . . . in-vehicle device, 4 . . . information processing server, 5 . . . communication network, 6 . . . terminal device, 21 . . . front camera, 22 . . . monitor camera, 23 . . . GPS device, 24 . . . microphone, 25 . . . communication I/F, 31 . . . first processor, 32 . . . first memory, 33 . . . first communication device, 41 . . . second processor, 42 . . . second memory, 43 . . . second communication device, 61 . . . third processor, 62 . . . third memory, 63 . . . third communication device, 64 . . . touch panel, 65 . . . speaker, 80 . . . editing tag, 81 . . . first element editing tag, 81a . . . text information, 81b . . . moving image scenario, 81c . . . photographed image, 82 . . . second element editing tag, 82a . . . text information, 82b . . . music scenario, 130 . . . editing tag, 131 . . . first element editing tag, 131a . . . text information, 131b . . . photographed image, 132 . . . second element editing tag, 132a . . . text information, 311 . . . event detection unit, 312 . . . information acquisition unit, 313 . . . tag creation unit, 313a . . . scenario creation unit, 314 . . . transmission unit, 321 . . . first program, 322 . . . face photo information, 323 . . . vehicle model information, 411 . . . creation unit, 412 . . . composite information acquisition unit, 413 . . . notification unit, 421 . . . second program, 611 . . . request unit, 612 . . . display control unit, 613 . . . voice control unit, 621 . . . third program, 900 . . . tag creation unit, 901 . . . photographed moving image information, 902 . . . voice information, 1000 . . . scenario creation unit, 1001 . . . corresponding information acquisition unit.

1. An information processing system comprising:
an event detection unit configured to detect occurrence of an event inside and outside a vehicle;
an information acquisition unit configured to acquire event related information related to the event;
a tag creation unit configured to create an editing tag based on the event related information; and
a creation unit configured to create content based on the editing tag.

2. The information processing system according to claim 1, wherein
the event detection unit detects the occurrence of an event based on at least one of photographed moving image information acquired from a camera that photographs inside and outside of the vehicle, position information acquired from a position information acquisition device that acquires position information of the vehicle, and voice information acquired from a microphone that collects voice inside and outside the vehicle.

3. The information processing system according to claim 2, wherein
the content includes a plurality of content elements, and
the tag creation unit generates the editing tag for each of the plurality of content elements.

4. The information processing system according to claim 3, wherein
the plurality of content elements include a moving image element and a music element, and
the creation unit
creates a first element editing tag including at least one of text information of the event, the text information being created based on the event related information, scenario information of a moving image, and image information photographed when the event is detected, as an editing tag of the moving image element, and
creates a second element editing tag including at least one of text information of the event, the text information being created based on the event related information, and scenario information of music to be combined with the moving image, as an editing tag of the music element.

5. The information processing system according to claim 4, comprising the vehicle and an information processor that can communicate with the vehicle, wherein
the vehicle includes
the tag creation unit and
a transmission unit configured to transmit the editing tag to the information processor,
the information processor includes
the creation unit and
a composite information acquisition unit configured to acquire at least one of vehicle information and occupant information,
the tag creation unit includes a scenario creation unit configured to create scenario information of the moving image based on the event related information, and
the creation unit creates the moving image based on the scenario information of the moving image, and combines an image based on the information acquired by the composite information acquisition unit with the created moving image.

6. The information processing system according to claim 3, wherein
the plurality of content elements include a moving image element and a music element, and
the creation unit
creates a first element editing tag including at least one of text information of the event, the text information being created based on the event related information, and image information photographed when the event is detected, as an editing tag of the moving image element, and
creates a second element editing tag including text information of the event, the text information being created based on the event related information, as an editing tag of the music element.

7. The information processing system according to claim 6, comprising the vehicle and an information processor that can communicate with the vehicle, wherein
the vehicle includes a transmission unit configured to transmit the editing tag to the information processor,
the information processor includes
the creation unit,
a scenario creation unit configured to create scenario information of a moving image and scenario information of music to be combined with the moving image based on text information of the event, and
a corresponding information acquisition unit configured to acquire the moving image information and the voice information inside and outside the vehicle corresponding to the scenario information of the moving image and the scenario information of the music, and
the creation unit creates the content based on the scenario information of the moving image, the scenario information of the music, and the moving image information and the voice information inside and outside the vehicle, the moving image information and the voice information being acquired by the corresponding information acquisition unit.

8. The information processing system according to claim 6, comprising the vehicle and an information processor that can communicate with the vehicle, wherein
the vehicle includes a transmission unit configured to transmit the editing tag to the information processor,
the information processor includes
the creation unit,
a scenario creation unit configured to create scenario information of a moving image based on text information of the event,
a corresponding information acquisition unit configured to acquire the moving image inside and outside the vehicle corresponding to the scenario information of the moving image, and
a composite information acquisition unit configured to acquire at least one of vehicle information and occupant information, and
the creation unit creates the moving image based on the scenario information of the moving image and the moving image inside and outside the vehicle, the moving image being acquired by the corresponding information acquisition unit, and combines an image based on the information acquired by the composite information acquisition unit with the created moving image.

9. An information processing method executed by a computer of an information processing system, the method comprising:
an event detection step of detecting occurrence of an event inside and outside a vehicle;
an information acquisition step of acquiring event related information related to the event;
a tag creation step of creating an editing tag based on the event related information; and
a creation step of creating content based on the editing tag.
